(19) United States
(12) Patent Application Publication
(10) Pub. No.: US 2006/0130400 A1
(43) Pub. Date: Jun. 22, 2006

(54) Device and method for producing hydrogen without the formation of carbon dioxide

(75) Inventor: Burnard P. Bockris, Gainesville, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: World Hydrogen, Inc., Gainesville, FL (US)

(21) Appl. No.: 11/019,914

(22) Filed: Dec. 21, 2004

(51) Int. Cl. B01J 7/00

(52) U.S. Cl. 48/61

(57) ABSTRACT

A conduit is arranged in a substantially vertical configuration and has an input and an output for passing a gas through the conduit interior. A catalyst material is present within the conduit. A heat source heats the conduit to a sufficiently high temperature so that the gas reacts with the catalyst and produces a byproduct and hydrogen gas. A vibrator or other mechanical device is coupled to the conduit and causes the carbon to detach from the conduit body. Also provided is a method for producing hydrogen gas.

### BACKGROUND OF THE INVENTION

1. Field of the Invention

The present invention relates generally to the field of hydrogen production, and more particularly relates to the production of hydrogen, while producing little or no carbon dioxide (CO₂).

2. Description of the Related Art

The United States and virtually every other country in the world depend almost exclusively on fossil-fuel-powered transportation. Our planes, trains, automobiles, and other engine-powered devices operate by burning petroleum products such as gasoline and diesel fuel. Fossil fuel, however, is a finite resource. According to some projections, its sources will begin to decline in rate of delivery as early as 2010. Currently, the loss of a reliable supply of fossil fuel would have a devastating effect on the whole of western society. For example, people would not be able to travel to work, factories would not be able to transport their products, and emergency services could not be delivered.

In addition to the impending exhaustion of the earth's fossil-fuel resources, fossil fuels suffer from at least four major disadvantages.

1. Air Pollution

When an engine burns gasoline or diesel fuel, carbon dioxide (CO₂) and carbon monoxide (CO), a poisonous gas, is emitted as a byproduct. In addition to carbon dioxide and carbon monoxide, the process of burning gasoline or diesel fuel further produces nitrogen oxides, the main source of urban smog, and unburned hydrocarbons, the main source of urban ozone. All of these chemicals have been medically proven to be detrimental to human health. In big cities and other largely populated areas, poor air quality can have a profoundly accelerated damaging effect on human health.

2. Environmental Pollution

Fossil fuels must be harvested, transported, stored, processed, further transported, and stored at the dispensing stations. These steps, particularly in the case of oil, can, and have, led to accidents that have almost irreparably damaged the earth's environment. Even minor oil spills, which happen rather frequently, are deadly to wildlife, detrimental to human health, costly, and difficult to clean.

3. Global Warming

The process of burning gasoline or diesel fuel in a combustion engine results in the emission of carbon dioxide into the atmosphere. Carbon dioxide is classified as a “greenhouse gas” that is attributed with causing a slow temperature rise on the planet. Global warming is caused by the accretion into the atmosphere of CO₂ because CO₂ acts as an absorber of the infrared part of the spectrum of the sun, and, as a result, the atmosphere, and the Earth, heat up. If the emission of carbon dioxide is not eliminated or at least reduced, it is projected that the affects of the greenhouse effect will be devastating to life on the planet Earth. The increase in temperature will melt the ice caps, causing an increase in sea level that will result in flooding and the destruction of coastal cities in existence today.

4. Dependence

Because the United States is incapable of producing enough oil to meet its own demands, it depends on other oil-producing countries to provide that supply. This dependence leads to economic dependence and unfavorable foreign policies.

5. The Alternative

A viable alternative to fossil fuel is hydrogen. Hydrogen, unlike petroleum based fuels, does not suffer from any of the above-mentioned disadvantages. Hydrogen is a completely clean fuel, whose only byproduct is water. Thus, hydrogen, when burned, does not produce any of the greenhouse gasses that fossil fuels produce. Additionally, there is never a fear of environmental damage due to a spill, as the hydrogen will simply dissipate into the air.

Several methods have been developed to produce hydrogen. However, all current methods of producing hydrogen in large-scale quantities result in the byproduct of carbon dioxide (CO₂) and other damaging greenhouse gases. Therein lies the conundrum; a completely clean fuel that does not create pollution is produced, but yet the process of producing the hydrogen generates dangerous gases that are released into the atmosphere and cause global warming.

One current method for producing hydrogen without producing CO₂ is from natural gas, which consists primarily of methane (CH₄), which contains hydrocarbons-molecules consisting of hydrogen and carbon. When methane is heated to a proper temperature-greater than 1000 degrees Celsius—the hydrogen molecules separate from the methane and the residue is powdered carbon (C). No CO₂ is formed. To facilitate the separation of the hydrogen and carbon from methane, the methane gas is passed through a heated chamber, or conduit. Furthermore, a catalyst is present within the heated chamber, which causes the dissociation reaction to take place.

However, the process of separating hydrogen and carbon from methane results in a carbon coating deposited on the catalyst. As the carbon coating builds up, the catalyst's ability to facilitate the separation process becomes diminished and finally eliminated. The device becomes less and less efficient until it no longer functions to convert the methane gas.

Accordingly, a need exists for a device and method for producing clean hydrogen from natural resources with reduced byproducts that are harmful to the atmosphere or inhibit the production process.

### SUMMARY OF THE INVENTION

Briefly, in accordance with the present invention, disclosed is a conduit or other chamber (ex. cylindrical pipe or tube) that can be heated to a temperature of approximately 1000 degrees Celsius or greater. In one embodiment, one or more resistive heaters heat the conduit. In other embodiments of the present invention, the pipe or tube itself may be used as the heated element and the methane can be preheated before it enters the reacting conduit with the catalyst. In yet another embodiment, laser energy, directed convection flow, heat elements, or any other heat generating means heats the conduit.

A flow of gas is introduced into and through the conduit. In one embodiment of the present invention, the gas is methane (CH₄) and the heat within the conduit causes each methane molecule to split into two hydrogen molecules (2H₂) and one carbon atom (C). The pure hydrogen is released from one end of the conduit while the carbon remains in the conduit. The hydrogen then rises and is channeled to systems where it may be used or stored.

In one embodiment of the present invention, a catalyst, such as nickel or cobalt oxides in porous form, is provided on the inside surface of the conduit to bring about the dissociation of the hydrogen and carbon. In yet another embodiment, the catalyst is deposited on strips of material that are placed within the conduit. In another embodiment, the catalyst is present on any surface available within the conduit, e.g., small silica spheres coated with metal catalyst which would include metallic oxides. In still one more embodiment, a porous catalyst fills the conduit opening.

To prevent the carbon from coating the catalyst to a point where the catalyst is not longer functional in causing the methane to separate, the device is oriented so that the conduit is in a relatively vertical position. In one embodiment of the present invention, a vibration generator is attached to the conduit. The vibration generator is operable to send at least one vibration wave, or “shock,” through the conduit. In one embodiment, the vibration generator can send a series of vibrations, or shocks, throughout the conduit, which could be thousands of vibrations, or more, each second.

The vibration acts on the catalyst-containing surfaces and causes the carbon to fall from the catalyst. With the conduit in the vertical position, the carbon will fall down and out of the conduit and is collected for disposal or other uses. The vibrations can be ultrasonic, single pulses, or any variation of frequency and amplitude that is effective in causing the carbon to become detached from the catalyst.

In another embodiment, the catalyst is provided on strips of material and held within the conduit, also in a vertical position. The strips are held at each end and at least one of the ends is twisted so that the material distorts and the rigid carbon falls from the catalyst surface.

In yet another embodiment of the present invention, pressure is applied at or near one or both of the ends of the strip so that the ends are forced in a direction away from one another thereby causing stretching to occur and the material to distort. The stretching causes the carbon to become detached from and fall from the catalyst.

In still another embodiment of the present invention, pressure is applied at or near one or both of the ends of the strip so that the ends are forced in a direction toward one another causing the strip to bend or flex inwardly, distorting the strip. The flexing causes the carbon to become detached from and fall from the catalyst.

In one more embodiment of the present invention, a vibration generator is attached to or coupled to the strips. The vibration generator is operable to send at least one vibration wave through the strip, causing the carbon deposits to become detached from and fall from the catalyst. With the conduit in the vertical position, the carbon will fall down and out of the conduit and is collected for disposal or other uses. The vibrations can be ultrasonic, single pulses, or any variation of frequency and amplitude that is effective in causing the carbon to become detached from the catalyst.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is schematic diagram illustrating a catalyst-containing conduit with a heating element according to an embodiment of the present invention.

FIG. 2 is a diagram illustrating the conduit of FIG. 1 with a vibrational device and carbon container according to an embodiment of the present invention.

FIG. 3 is a diagram illustrating a cutaway view of a conduit with catalyst-supporting strips and a strip-manipulating device according to another embodiment of the present invention.

FIGS. 4A-4D are diagrams illustrating four possible manipulations of the strips of FIG. 3.

FIG. 5 is a diagram illustrating catalyst material filling an interior area of the conduit of FIG. 1.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

While the specification concludes with claims defining the features of the invention that are regarded as novel, it is believed that the invention will be better understood from a consideration of the following description of preferred embodiments in conjunction with the drawing figures, in which like reference numerals are carried forward.

Described now is an exemplary method and device for mass producing pure hydrogen while producing little or no CO₂. The method and device, as described herein, result in a supply of pure hydrogen and solid carbon. The carbon is carefully collected for sale, storage, use in other applications, or easily disposed of in an environmentally-friendly manner.

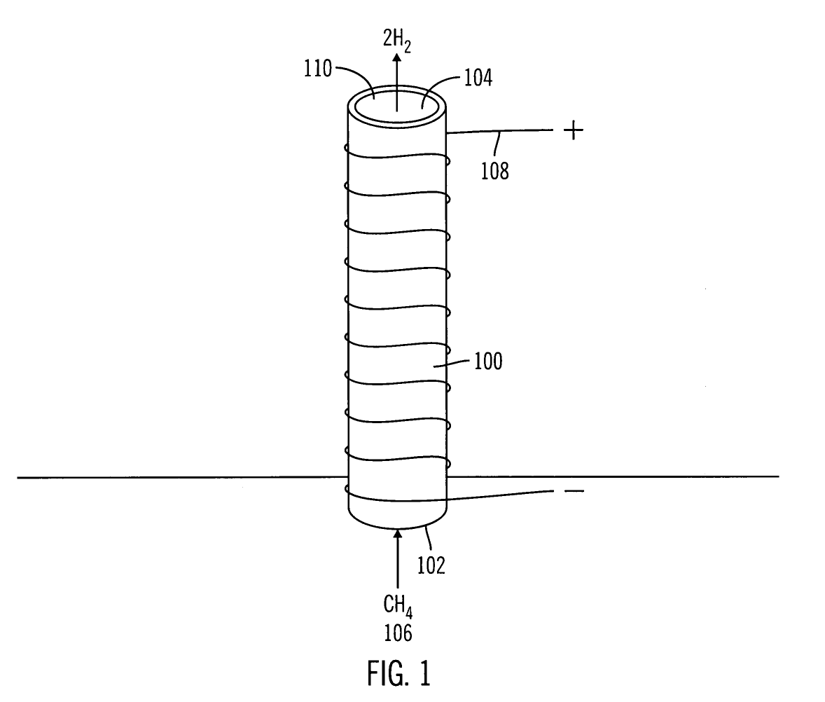

Referring now to FIG. 1, one embodiment of the conduit 100 according to the present invention is shown. The conduit 100 of this exemplary embodiment has a tubular shape, but the invention is not so limited and other shapes can be used without departing from the true spirit and scope of the invention. The conduit 100 can be any chamber that has at least one entrance 102 and at least one exit 104 (which could alternatively be the entrance) which a stream of gas 106 can pass through. Additionally, the length of the conduit can vary and is not limited to any particular length. For example, the conduit 100 may be four (4) feet in length, three (3) feet of which will be expected to reach the operating temperatures.

A heater 108 heats the conduit to within a defined temperature range. The heater 108 shown in FIG. 1 is a schematical representation of a resistive heater, however, many other techniques and devices for applying heat to the conduit 100 will work equally as well to realize the objects of the present invention, including contact and non-contact heating methods working by heat convection, heat conduction, heat radiation, or some combination of these. These heating methods include laser, focused laser beam, directed convection flow, and heat elements. Where and how the heat source is applied to the conduit 100 depends on the particular physical details of the conduit being used.

In one embodiment of the present invention, the defined heated operating temperature range within the conduit is from about 1000 degrees Celsius to about 1050 degrees Celsius. However, the invention is not so limited and other temperatures may be applied to the conduit 100 to accomplish the goals of the present invention. For example, it has been shown that increasing the length of the conduit 100 can have the resulting effect of increasing the amount of time the gas is exposed to the heated environment within the conduit 100.

If methane (CH₄) gas is introduced within the conduit 100, the above-described heat within the conduit acts upon the gas and causes each methane molecule to separate into one carbon atom (C) and two hydrogen molecules (2H₂) according to the following equation.

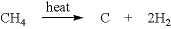

The process is described in Hydrogen via Methane Decomposition: an Application for Decarbonization of Fossil Fuels, Nazim Muradov, International J. of Hydrogen Energy 26 (2001) 1165-1175, the entire teachings of which being hereby incorporated by reference.

In one embodiment of the present invention, the process is expedited by pre-heating the methane or other gas used, such as argon, before introducing it into the conduit 100. Additionally, oxygen must be rigorously eliminated from the environment to prevent combustion of the heated gas and to prevent formation of CO₂.

To facilitate the separation, a catalyst 110 is provided on the inside surface of the conduit 100. The catalyst 110 allows the process to take place at a much more rapid rate than it would without the catalyst 110. In one embodiment of the present invention, the catalyst is iron oxide and is adhering to the inside surface in an adsorbed fashion in small particles of approximately 1 micron or less in size. The invention, however, is not so limited and other catalyst materials can be used, such as iron, cobalt, molybdenum, nickel, nickel oxide, tungsten, and tungsten oxide, among others. The catalyst materials can also be provided in various sizes.

The carbon that is removed from the methane gas is in a solid, or powder form and attaches to the walls of the conduit. The hydrogen, a gas, passes out of the exit 104 of the conduit 100. If the separation process continues to occur in this manner however, deposits of carbon would build up on the catalyst material 110, blocking the catalyst 110 until it would become no longer effective in affecting the separation of the methane gas.

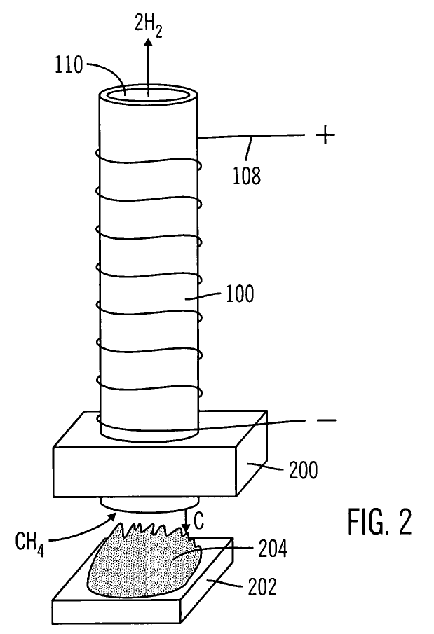

Referring now to FIG. 2, to prevent the carbon from building and densely coating and blocking the catalyst 110, the conduit 100 is arranged-in-a substantially vertical orientation. Additionally, a vibration-generating device (“VGD”) 200 is coupled to the conduit 100. The VGD 200 is capable of sending vibration waves through the conduit 100 and/or the catalyst material 110. The vibrations are such that the solid carbon particles become unattached from the catalyst 110 and fall down and out of the conduit 100. The term “vibration” as used here mean a single movement or a series of movements, either uniform or non-uniform. The purpose of the VGD 200 is to cause the carbon to separate from the catalyst 110 and many embodiments are possible. In one embodiment of the present invention, the vibrations are ultrasonic. In still another embodiment of the present invention, the vibrations are applied from the sides, from the top, and/or from the bottom of the conduit, or other locations, so that all portions of the catalyst receive vibrations. In other embodiments, the vibrations may be delivered through sonic, or air pulses.

In the exemplary embodiment of the present invention shown in FIG. 2, a container 202 is located directly below the conduit 100 and catches the carbon 204 as it falls from the vertically oriented conduit 100. The carbon 204 can then be removed for sale or disposal. The container 202 can be coupled to the conduit 100 or separate from the conduit 100. In one embodiment, the atmosphere in which the container is held is argon and oxygen rigorously excluded.

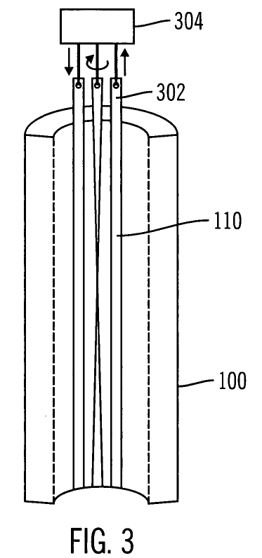

Referring now to FIG. 3, another embodiment of the present invention is shown. FIG. 3 depicts a cut-away view of a conduit 100. In this embodiment, catalyst material 110 may or may not be present on the inside surface of the conduit. However, catalyst 110 is present on strips 302, which are coated or made of the catalyst material 110 and located within the conduit 100. The strips are attached at at least one end to a device 304. The other end can be attached or coupled to the conduit 100, as shown in FIG. 3, or attached to second device (not shown).

As the interior of the conduit 100 is heated and methane is passed through, the catalyst containing strips 302 facilitate the chemical separation of the methane. Over time, as described above in relation to the catalyst coated walls of the conduit 100, if nothing was done, the catalyst coated strips 302 would become covered in carbon and no longer function for their intended purpose. Additionally, a substantial portion of the interior of the conduit would become full of carbon deposits and at least partially block the path for the methane to pass. If the methane cannot enter the conduit, the process will not occur and no hydrogen formation will be possible.

However, in this embodiment, device 304 mechanically applies a movement to the strips 302 in a manner that causes the carbon to unattach itself from the strips. The movement, as indicated by the arrows in FIG. 3, could be, among others, stretching the strips, twisting the strips, compressing the strips, or vibrating the strips. The strips are strong enough to sustain themselves during compression and expansion (pulling and pushing). The physical characteristics of the device 304 of FIG. 3 are shown for exemplary purposes only and the device does not have to resemble the embodiment shown. It is clear from the description of the device 304 that many other embodiments can be used to achieve the desired results. For example, any number of strips can be contained within the conduit. Further, the strips may not pass beyond the length of the conduit in all embodiments.

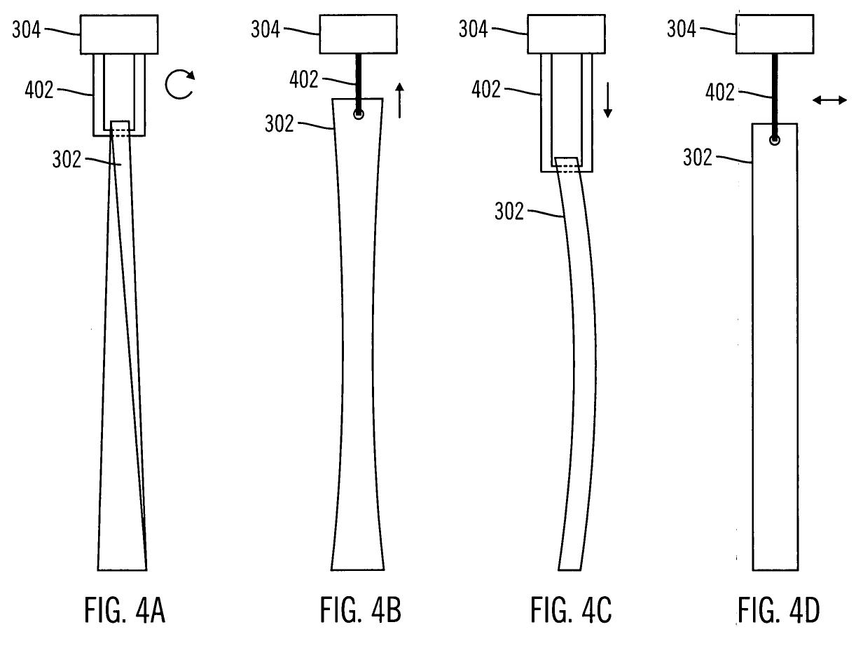

FIGS. 4A-4D show a few examples of how the strips 302 can be manipulated with the device 304. In all of the examples shown, the device 304 is attached to a strip 302 with an arm 402. The other end of the strip is secured and stationary. Referring first to FIG. 4A, the device 304 causes the arm 402 to twist in a direction substantially perpendicular to the plane of the paper. The amount of rotation can vary depending on the strip material, thickness, width, and other factors. The twisting motion causes the strip 302 to distort from its normal planar orientation, causing a lateral force to be applied to the solid carbon deposits, resulting in a separation from the strip 302.

In FIG. 4B, the device 304 applies a pulling force to the strip 302 through the use of arm 402. In one embodiment, the strip 302 is made of a material that has an element of elasticity, allowing it to return to its original shape and dimensions after it has been stretched. The pulling force causes the strip 302 to stretch and slightly distort from its normal shape thus causing the powdered carbon attached to the catalyst to fall off and reach the collecting vessel 202 below.

In FIG. 4C, the device 304 applies a downward or compression force on the strip 302. As a result, the strip 302 bends near its center, thus distorting the carbon-carrying surfaces of the strip 302, causing the carbon to fall from the surface of the strip.

In the FIG. 4D, the device 304 is a vibration generator and is operable to place vibrational energy into the strip 302. The vibrational energy is sufficient to shake the carbon deposits loose from the surface of the strip 302. The vibration can be a single movement of the strip or a series of back-and-forth movements in any direction and the vibrations can be either uniform or non-uniform.

In some embodiments of the present invention, a second device is attached at the opposite end of the strips 302. The two devices work together in such embodiments to create more movement, force, or vibration on the strip 302 than is created with a single device 304. The first and second devices do not have to apply the same types of force to the strip. For example, one device could stretch the strip while the other device causes vibration.

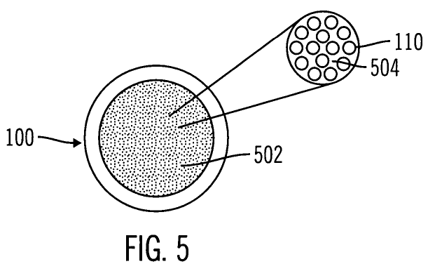

Referring now to FIG. 5, another embodiment of the present invention is shown. In this embodiment, the interior area 502 of the conduit 100 is at least partially filled with catalyst material 110. In this embodiment, the catalyst material may have a slightly larger size than the catalyst material used on the strips 302 or the interior walls of the conduit 100. For instance, the catalyst 110 can have a particle size of approximately 10 microns as opposed to catalyst material, as described above, applied to the wall surface or strips, which can be 1 micron or less in size. The larger size catalyst particles provide pores 504 between each particle, through which the gas may pass. As with the other embodiment, vibrations placed upon the catalyst material will dislodge carbon deposits within the pores 504 and again expose the catalyst material 110.

As is clear from the preceding description, any means of causing the carbon to fall from the surface of the strips 302, the interior surface 104 of the conduit, or any other surface within the conduit 100 produces the desired results. With the continuous removal of carbon from the conduit, the mass production of pure hydrogen with little or no greenhouse gasses is realized.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

What is claimed is:

1. An apparatus for producing hydrogen, the apparatus comprising:
a conduit having at least one input and at least one output for allowing a gas to pass through at least a portion of an interior of the conduit;
a heat source for heating the conduit; and
a vibrator coupled to the conduit for causing the conduit to vibrate such that at least one chemical deposit detaches from the interior of the conduit.

2. The apparatus according to claim 1, wherein the conduit is arranged in a substantially vertical orientation.

3. The apparatus according to claim 1, wherein the chemical deposit comprises a byproduct of decomposition of the gas.

4. The apparatus according to claim 1, further comprising a catalyst provided on a surface of the interior of the conduit.

5. The apparatus according to claim 4, wherein the catalyst comprises at least one of iron oxide, iron cobalt, nickel oxide, tungsten, and molybdenum.

6. The apparatus according to claim 1, further comprising a catalyst provided within the conduit.

7. The apparatus according to claim 1, wherein the heat source produces a temperature between about 950 degrees Celsius and about 1050 degrees Celsius.

8. The apparatus according to claim 1, wherein the vibrator causes at least one vibrational wave to travel through the interior of the conduit and/or the catalyst.

9. The apparatus according to claim 1, wherein the gas comprises one of methane and a mixture of hydrocarbons.

10. An apparatus for producing hydrogen, the apparatus comprising:
a conduit having at least one input and at least one output for allowing a gas to pass through at least a portion of an interior of the conduit;
at least one catalyst-supporting material disposed within the conduit, the catalyst supporting-material being at least partially covered with a catalyst;
a heat source for heating the conduit; and
a mechanical device coupled to the catalyst-supporting material for causing at least one chemical deposit to detach from the catalyst.

11. The apparatus according to claim 10, wherein the conduit is arranged in a substantially vertical orientation.

12. The apparatus according to claim 10, wherein the chemical deposit comprises a byproduct of decomposition of the gas.

13. The apparatus according to claim 10, wherein the catalyst-supporting material comprises a first end and a second end, and the mechanical device is coupled to at least one of the first end and the second end of the catalyst-supporting material; the mechanical device being operable to stretch the catalyst-supporting material.

14. The apparatus according to claim 10, wherein the catalyst-supporting material comprises a first end and a second end, and the mechanical device is coupled to at least one of the first end and the second end of the catalyst-supporting material; the mechanical device being operable to twist the catalyst-supporting material.

15. The apparatus according to claim 10, wherein the mechanical device causes the catalyst-supporting material to distort its shape.

16. The apparatus according to claim 10, wherein the mechanical device is operable to cause at least one vibrational wave to travel through the catalyst-supporting material.

17. The apparatus according to claim 10, wherein the catalyst comprises iron oxide.

18. The apparatus according to claim 10, wherein the heat source produces a temperature between about 950 degrees Celsius and about 1050 degrees Celsius.

19. The apparatus according to claim 10, wherein the gas comprises methane.

20. A method of producing hydrogen, the method comprising:
applying heat to a conduit;
passing a gas through the heated conduit, such that the gas decomposes and a byproduct of the gas is produced; at least a portion of the byproduct adhering to a surface within the conduit; and
applying at least one physical force to the surface within the conduit, so as to cause the byproduct to separate from the surface.

21. The method according to claim 20, wherein the gas comprises methane.

22. The method according to claim 20, wherein the byproduct is carbon.

23. The method according to claim 20, wherein the surface within the conduit is at least partially covered with a catalyst.

24. The method according to claim 23, wherein the catalyst comprises at least one of iron oxide and nickel oxide.

25. The method according to claim 20, wherein the operable temperature is between about 950 degrees Celsius and about 1000 degrees Celsius.

26. The method according to claim 20, wherein an axial dimension of the conduit is substantially vertially oriented.

27. The method according to claim 20, wherein the physical force is at least one of a vibration, a stretching, a twisting, and a compression.

28. The method according to claim 20, wherein the surface within the conduit comprises one of an interior surface of the conduit and at least one strip of material within the conduit.
